(19) United States
(12) Patent Application Publication
(10) Pub. No.: US 2010/0279632 A1
(43) Pub. Date: Nov. 4, 2010

(54) COMMUNICATION APPARATUS

(75) Inventors: Wataru Iwazaki, Isesaki-shi (JP); Hiroaki Saitou, Isesaki-shi (JP); Masato Yoshii, Isesaki-shi (JP); Masakazu Suga, Isesaki-shi (JP); Tetsuya Mashimo, Isesaki-shi (JP); Saori Kuribara, Isesaki-shi (JP); Takahiro Ikeda, Isesaki-shi (JP); Munenori Fukamachi, Isesaki-shi (JP)

Correspondence Address: GREER, BURNS & CRAIN, 300 S WACKER DR, 25TH FLOOR, CHICAGO, IL, 60606, US

(73) Assignee: SANDEN CORPORATION, Isesaki-shi, (JP)

(21) Appl. No.: 12/743,415

(22) PCT Filed: Nov. 18, 2008
(86) PCT No.: PCT/JP2008/070948

§ 371 Date: May 18, 2010

(30) Foreign Application Priority Data
Nov. 19, 2007 (JP) 2007-299252

(51) Int. Cl. H04B 1/38

(52) U.S. Cl. 455/90.2

(57) ABSTRACT

A communication apparatus comprising a communication module that serves as Data Circuit-terminating Equipment used in a radio packet communication network; an auxiliary circuit board on which said communication module is mounted; a main circuit board on which a communication controller is mounted; and a signal line for connecting said main circuit board to the auxiliary circuit board detachably; wherein said main circuit board further comprises a detecting means for detecting a type of the connected communication module based on a pattern of a signal status on the signal line at a start-up, and said communication controller performs a communication control operation in accordance with a result of detection by the detecting means.

### TECHNICAL FIELD

The present invention relates to a communication apparatus used in the field of telemetering used for such purposes as collection of sales information from vending machines or the field of telematics used for distribution of traffic information to mobile objects or the like.

### BACKGROUND ART

Recently, telemetering and telematics for collecting and distributing information over a radio packet communication network have become widespread. The telemetering originally refers to a system for reading a measured value by a measurement instrument via a communication line. However, it has been generally used as a term indicating not only reading data but also monitoring the operation of equipment and performing remote control. A typical application of telemetering can be a sales management system of a vending machine, used amount management system of a gas, water supply, etc., and a management system for unmanned parking lots, etc. For a sales management system of a vending machine, refer to the patent document 1. The telematics refers to providing information service in real time by combining a mobile object such as an automobile with a communication system. A typical application of telematics can be a vehicle-mounted information system etc. for providing a terminal provided on a vehicle with traffic information and navigation information in real time.

In such fields, a user in a remote location would require Data Circuit-terminating Equipment (DCE) and Data Terminal Equipment (DTE) using the Data Circuit-terminating Equipment. In the sales management system of a vending machine, for instance, the Data Terminal Equipment corresponds to a control device for controlling sales processes and inside temperature. The Data Terminal Equipment connects to a predetermined network via the Data Circuit-terminating Equipment regularly or at random timing, and connects to a predetermined management computer via the network. And then the Data Terminal Equipment connected to the management computer transmits various sets of data relating to the objects to be controlled.

In recent years, there have been requests to change the carrier of the radio packet communication network and its services after having constructed such system. However if the carrier and the services are changed, the Data Circuit-terminating Equipment also must be changed. Therefore the Data Terminal Equipment also must be changed or modified. Since the Data Terminal Equipments are located at various distant places, if a lot of Data Terminal Equipments are already installed in market, a workload for the changes and the modification of the Data Terminal Equipments is heavy. And similar problems may arise in case of model changes of the Data Terminal Equipment even if the carrier and the services are not changed. Further such problems will arise in case of future changes of the carrier, services and model. Therefore it is important to circumspectly select the carrier, services and model.

To solve such problems, a communication apparatus comprising Data Circuit-terminating Equipment and a communication controller which intervene between the Data Circuit-terminating Equipment and Data Terminal Equipment, is proposed (see the patent document 2). This communication apparatus comprises, in a case, a main circuit board on which the communication controller is mounted and an auxiliary circuit board on which the Data Circuit-terminating Equipment is mounted. The main circuit board is connected to the auxiliary circuit board by a signal line detachably. The communication controller performs communication controls such as protocol conversion, address conversion, authentication proxy and connection process in order to absorb differences of plural kind of Data Circuit-terminating Equipments, carriers and services. The communication apparatus provides that Data Circuit-terminating Equipment can be replaced along with the auxiliary circuit board without changing and modifying the Data Terminal Equipment.

PATENT DOCUMENT 1: Japanese Patent Publication 2003-51056

PATENT DOCUMENT 2: Japanese Patent Publication 2006-245956

### DISCLOSURE OF THE INVENTION

### Problems to be Solved by the Invention

As described above, in the apparatus of the patent document 2, the communication controller performs behavior corresponding to a type of the Data Circuit-terminating Equipment. Accordingly the communication controller needs to detect the type of the connected Data Circuit-terminating Equipment. The patent document 2 discloses a method for recognizing of which a memory or a switch for recognition is provided on the auxiliary circuit board and the communication controller of the main circuit board reads values of the memory or the switch. And the patent document 2 discloses another method for recognizing that the communication controller identifies the type based on contents of communication messages with the Data Circuit-terminating Equipment.

However the former method has a problem that the number of the types transmittable from the auxiliary circuit board to the main circuit board is limited, because the number of the signal lines connecting between the main circuit board and the auxiliary circuit board is limited. On the other hand the latter method is premised on that the communication controller can communicate basically to the Data Circuit-terminating Equipment. That is, it is premised on that initial process for communicating to the Data Circuit-terminating Equipment is completed. However it may be impossible to start the initial process if the type of the Data Circuit-terminating Equipment can not be obtained because the initial process depends on the hardware specification.

In view of the above problems in the conventional art, the present invention has an object to provide a communication apparatus capable of performing initial process certainly with simple structure.

### Means for Solving the Problems

In order to achieve the object stated above, the present application proposes a communication apparatus comprising a communication module that serves as Data Circuit-terminating Equipment used in a radio packet communication network; an auxiliary circuit board on which said communication module is mounted; a main circuit board on which a communication controller is mounted; and a signal line for connecting said main circuit board to the auxiliary circuit board detachably; wherein said main circuit board further comprises a detecting means for detecting a type of the connected communication module based on a signal status on the signal line at a start-up, and said communication controller performs a communication control operation in accordance with a result of detection by the detecting means.

The signal status of the signal line at the start-up varies depending on the type of the communication modules. The present invention utilizes such characteristic of the communication module so that the detecting means detects the type of the connected communication module based on the pattern of the signal status on the signal line at the start-up. This provides that the type of the communication modules can be detected without any additional exclusive signal lines. Therefore a certain initial process can be performed.

As a preferable example of the invention, the present application also proposes the communication apparatus wherein said detecting means includes an encoding circuit for converting the pattern of the signal status on the signal line to a numerical value. This invention provides that the type of the communication modules can be detected as numerical value. Therefore the initial process can be performed certainly and simply.

Other objects, configurations, and advantages of the present invention will be made apparent in the following detailed descriptions.

### ADVANTAGES OF THE INVENTION

As described above, according to the present invention, the detecting means detects the type of the connected communication module based on the pattern of the signal status of the signal line at the start-up. This provides that the type of the communication modules can be detected without any additional exclusive signal lines. Therefore an initial process can be performed certainly with simple structure.

### BRIEF DESCRIPTION OF THE DRAWINGS

FIG. 1 shows a schematic configuration diagram of the communication apparatus;

FIG. 2 shows a block diagram of a main circuit board;

FIG. 3 shows a block diagram of an auxiliary circuit board;

FIG. 4 shows a block diagram of an auxiliary circuit board;

FIG. 5 shows a flow chart of an operation of the communication apparatus.

### DESCRIPTION OF SYMBOLS

1 communication apparatus
10 case
20 flat cable
100 main circuit board
101,102 connector
110,115 interface circuit
120 communication controller
130 detecting part
140 bus line
200 auxiliary circuit board
201,202 connector
210 bus line
220 interface circuit
230B memory chip
400 communication module
500 antenna

### BEST MODE FOR CARRYING OUT THE INVENTION

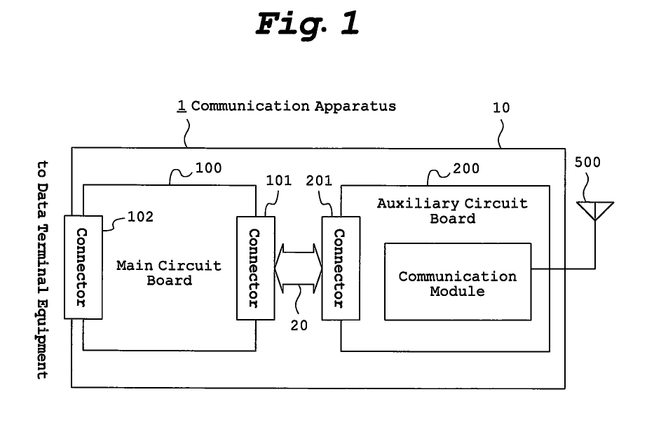

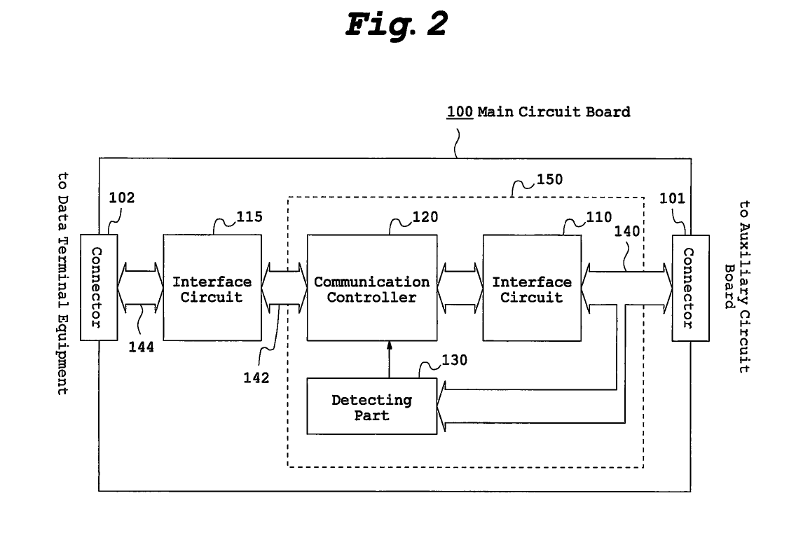

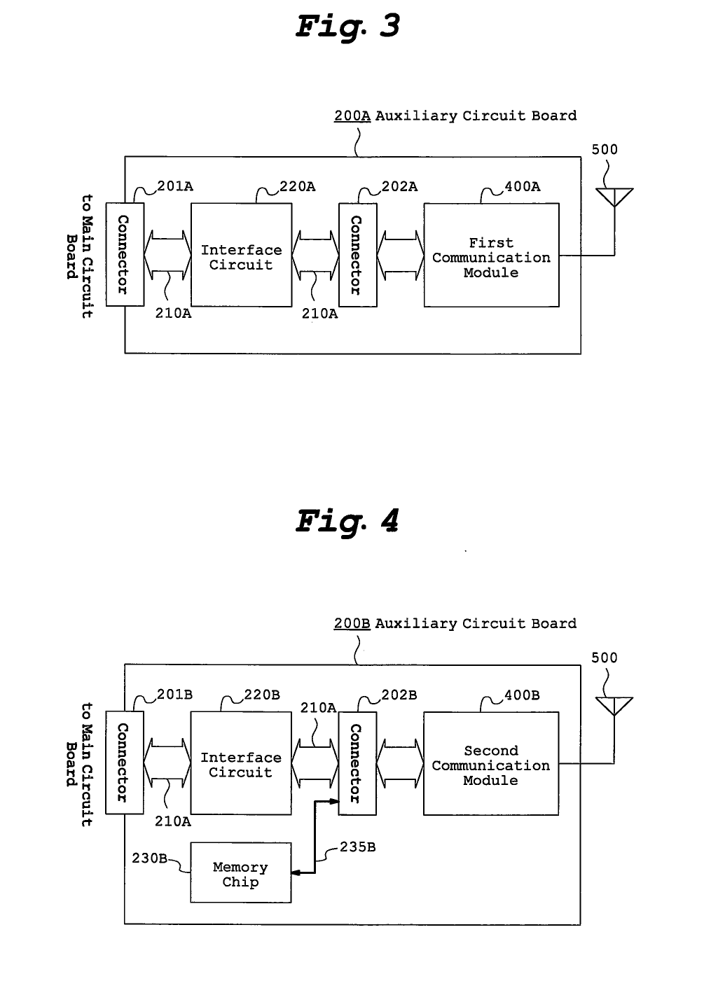

A communication apparatus, which is one embodiment of the present invention, will be described with reference to accompanying drawings. FIG. 1 shows a schematic configuration diagram of the communication apparatus. FIG. 2 shows a block diagram of a main circuit board. FIG. 3 and FIG. 4 show a block diagram of an auxiliary circuit board.

The communication apparatus 1 comprises, as shown in FIG. 1, a main circuit board 100 and an auxiliary circuit board 200 in a case 10. A connector 101 for connecting to the auxiliary circuit board 200, and a connector 102 for connecting to Data Terminal Equipment are mounted on the main circuit board 100. A connector 201 for connecting to the main circuit board 100 is mounted on the auxiliary circuit board 200. The connector 101 of the main circuit board 100 and the connector 201 of the auxiliary circuit board 200 are connected by a flat cable 20 including plural signal lines detachably. A communication module 400, which is Data Circuit-terminating Equipment for a radio packet communication network, is mounted on the auxiliary circuit board 200. The communication module 400 connects to an antenna 500 arranged outside the case 10 via a connector (not shown).

The main circuit board 100 comprises, as shown in FIG. 2, an interface circuit 110 for the auxiliary circuit board 200, an interface circuit 115 for the Data Terminal Equipment, a communication controller 120, a detecting part 130 for detecting a type of the communication module 400. The interface circuit 110 for the auxiliary circuit board 200 is connected to the connector 101 via a bus line 140. And the interface circuit 115 for the Data Terminal Equipment is connected to the connection controller 120 via a bus line 142. And the interface circuit 115 for the Data Terminal Equipment is connected to the connector 102 via a bus line 144. In this embodiment, the interface circuit 110 for the auxiliary circuit board 200, the connection controller 120 and the detecting part 130 are packaged in a FPGA (Field Programmable Gate Array) chip 150, which is a kind of a PLD (Programmable Logic Device).

The communication controller 120 performs a relay control of communications of the Data Terminal Equipment with the communication module 400, and performs communication controls such as protocol conversion, address conversion, authentication proxy and connection process as the needs arise. For instance, if the Data Terminal Equipment does not support services and protocols of the radio packet communication network to which the communication module 400 is to be connects, the communication controller 120 performs process to absorb the difference of the services and equipments such as address conversion process and authentication proxy process on behalf of the Data Terminal Equipment. This provides that any kind of network services can be used without changing or modifying the Data Terminal Equipment. In this embodiment, the communication controller 120 supports two types of communication module 400 named a first communication module 400A and a second communication module 400B. And the communication module 400 has two process modes corresponding to the each module. Further the communication controller 120 has a general-purpose process mode in preparation for the case where the communication controller 120 is unable to detect the type of the connected communication module 400. The communication controller 120 changes its process mode in accordance with the type of the communication module 400 which the detecting part 130 detected.

The detecting part 130 is inputted to signal lines which transmit signals from the auxiliary circuit board 200 to the FPGA chip 150 of which the signal lines is a part of the bus line 140 which is connected between the connector 201 for the auxiliary circuit board 200 and the FPGA chip 150. The signal lines inputting to the detecting part 130 include signal lines which transmit signals common with a plural types of the communication module 400. For example, the signal lines can be a RD (Receive Data) signal, a CS (Clear to Send) signal, a CD (Carrier Detect) signal, a CI (Call Indicate) signal and a DR (Dataset Ready) signal. Additionally the signal lines inputted to the detecting part 130 can include signal lines which transmit peculiar signals to the communication module. For example, the signal lines can be a signal line which transmits a signal relevant to the radio field intensity. The detecting part 130 acquires a signal status of said signal lines as the inputs at the start-up, and outputs a value corresponding to the type of the communication module 400 to the communication controller 120. That is, the detecting part 130 functions as an encoding circuit, wherein the input is the signal status of said signal lines and the encoding circuit converts a pattern of the signal status to a numerical value. In other word, if the pattern of the signal status matches a specific pattern, the detecting part 130 outputs a numerical value corresponding to the pattern. The plural patterns of the signal status are set up in advance so that the each pattern corresponds to each type of communication module 400. Here, the signal status of the said signal lines means a voltage level of the signal. For instance, if the signal status of a pin number (2, 3, 5, 6) of the connector 201 shows a first pattern (Low, Low, High, Low), the detecting part 130 outputs “1” as the value corresponding to the first communication module 400A. And if the signal status shows a second pattern (High, High, High, Low), the detecting part 130 outputs “2” as the value corresponding to the second communication module 400B. And if the signal status does not match to any patterns, the detecting part 130 outputs the specific value, for example “0”, which means failure of the detection.

Next, the auxiliary circuit board 200 will be described with reference to FIG. 3 and FIG. 4. FIG. 3 shows a block diagram of the auxiliary circuit board 200A on which the first communication module 400A is mounted. FIG. 4 shows a block diagram of the auxiliary circuit board 200B on which the second communication module 400B is mounted.

As described above, the connector 201A for connecting to the main circuit board 100 is mounted on the auxiliary circuit board 200A. And a connector 202A for connecting to the first communication module 400A is mounted on the auxiliary circuit board 200A. A bus line 210A connects the connector 201A with the connector 202A. An interface circuit 220A is mounted on the bus line 210A. The interface circuit 220A has functions of a pull-up, noise elimination, a backflow prevention, and etc. And pin assignments of the connector 201A and the connector 202A are converted by the wiring of the bus line 210A.

As well as said auxiliary circuit board 200A, the auxiliary circuit board 200B comprises a connector 201B for connecting to the main circuit board 100, a connector 202B for connecting to the second communication module 400B, a bus line 210B for connecting between the connector 201B and the connector 202B and a interface circuit 220B mounted on the bus line 210B. The interface circuit 220B has functions of a pull-up, noise elimination, a backflow prevention, and etc. And pin assignments of the connector 201B and the connector 202B are converted by the wiring of the bus line 210B. And a memory chip 230B is mounted on the auxiliary circuit board 200B. The memory chip 230B memorizes setting information such as telephone number information of the second communication module 400B. The memory chip 230B is required by specifications of the second communication module 400B. The memory chip 230B is connected to the second communication module 400B via a bus line 235B and the connector 202B.

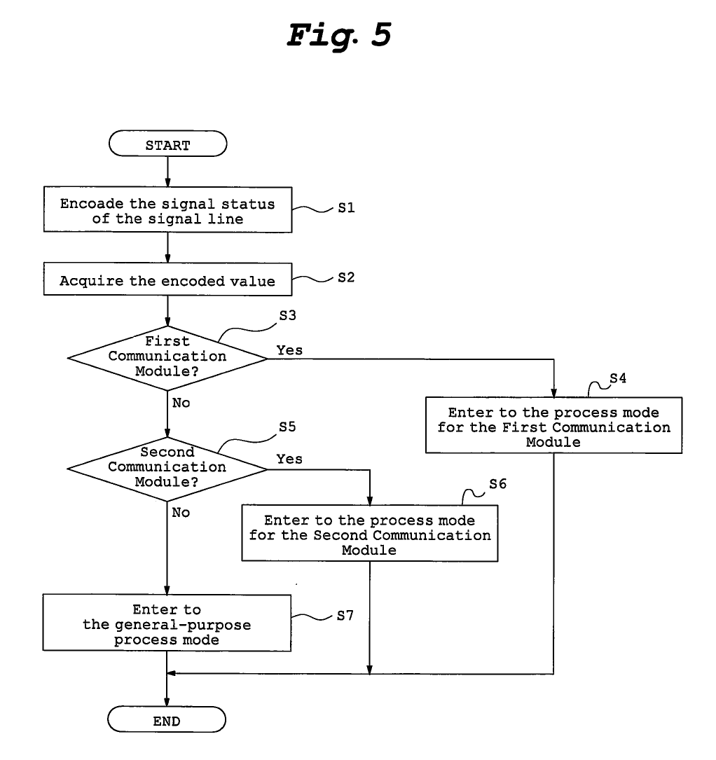

Next, the operation of the communication apparatus 1 will be described with reference to a flow chart of FIG. 5. When the communication apparatus 1 starts up on turning the power on, the detecting part 130 acquires the signal status of each input signal lines of the bus line 140 which is extended from the connector 101, as the input, and outputs the encoded value to the communication controller 120 (step S1).

The communication controller 120 acquires the encoded output from the detecting part 130 (step S2). Next, if the encoded value corresponds to the first communication module 400A, the communication controller 120 will enter to the process mode corresponding to the first communication module 400A (step S3, S4). And if the encoded value corresponds to the second communication module 400B, the communication controller 120 will enter to the process mode corresponding to the second communication module 400B (step S5, S6). On the other hand, if the encoded value is the specific value indicating the failure of detection, the communication controller 120 will enter to the general-purpose process mode (step S7, S8). And in each process mode, the communication controller 120 performs an initial process for the communication module 400.

The communication apparatus 1 of this embodiment provides that the communication controller 120 of the main circuit board 100 can perform the process mode certainly corresponding to the type of the communication module 400 mounted on the auxiliary circuit board 200. Especially the communication apparatus 1 of this embodiment enables to detect the communication module 400 without increasing signal lines connected between the main circuit board 100 and the auxiliary circuit board 200. Therefore the communication apparatus 1 can be designed with simple structure. This is useful if the communication apparatus 1 must support a lot of the communication modules 400. And in this embodiment, since the detecting part 130 is packaged in the FPGA together with the communication controller 120 as a logic circuit, the communication apparatus 1 can be designed with a small number of parts and simple structure.

Although the present invention has been described in detail so far with respect to one embodiment thereof, the invention is not limited to this embodiment. For instance, in the above embodiments, the communication controller 120 can further detect a detailed type of the communication module 400 in the process mode corresponding to the operation of the each communication module 400 after the communication controller 120 entered to the process mode on the basis of the result of the detecting part 130. In this additional detecting process, the communication controller 120 detects the detailed type on basis of the replay patterns in response to the command, when communicating with the communication module 400.

We claim:

1. A communication apparatus comprising:
a communication module that serves as Data Circuit-terminating Equipment used in a radio packet communication network;
an auxiliary circuit board on which said communication module is mounted;
a main circuit board on which a communication controller is mounted; and
a signal line for connecting said main circuit board to the auxiliary circuit board detachably;
wherein said main circuit board further comprises a detecting means for detecting a type of the connected communication module based on a pattern of a signal status on the signal line at a start-up, and said communication controller performs a communication control operation in accordance with a result of detection by the detecting means.

2. The communication apparatus according to claim 1, wherein:
said detecting means includes an encoding circuit for converting the pattern of the signal status on the signal line to a numerical value.
